(19) United States
(12) Patent Application Publication
(10) Pub. No.: US 2024/0208315 A1
(43) Pub. Date: Jun. 27, 2024

(54) UNIVERSAL CHASSIS FRAME FOR MEDIUM-DUTY CONFIGURABLE ELECTRIC TRUCKS

(71) Applicant: ZEUS ELECTRIC CHASSIS, INC., White Bear Lake, MN (US)

(72) Inventor: Robert L. Grinstead, Chisago City, MN (US)

(21) Appl. No.: 18/572,898

(22) PCT Filed: May 19, 2022
(86) PCT No.: PCT/US2022/030059

§ 371 Date: Dec. 21, 2023

Related U.S. Application Data
(60) Provisional application No. 63/190,474, filed on May 19, 2021.

(51) Int. Cl. B60K 1/02; B60B 35/00; B60K 1/04; B60K 17/356; B60L 50/60; B60L 58/20; B62D 21/03; B62D 27/06; B62D 29/00; B62D 63/02

(52) U.S. Cl. CPC B60K 1/02; B60B 35/005; B60K 1/04; B60K 17/356; B60L 50/66; B60L 58/20; B62D 21/03; B62D 27/065; B62D 29/007; B62D 63/025; B60K 2001/0438

(57) ABSTRACT

A universal chassis frame for medium-duty weight class electric trucks that interfaces with any of a set of multiple configurable rear payload modules. The universal chassis frame includes a central frame having a pair of main frame rails supporting at least two battery modules substantially within an intra-frame space defined between the pair of main frame rails and between at least a pair of cross members transversely interconnected to the pair of main frame rails. A front subframe supports a cab and includes a pair of upper frame members mounted directly above the main frame rails, and a front axle unit mounted under the front subframe. A rear subframe includes a common connection interface to any of the set of multiple configurable rear units and at least one rear axle unit mounted under the rear subframe. Each axle unit has a single electric motor powered by a battery management system.

### TECHNICAL FIELD

The present disclosure relates to understructures on which a vehicle body may mounted comprising longitudinal and transverse frame members and to the arrangement or mounting of electrical propulsion units and batteries relative to the frame members. More particularly, the present disclosure relates to a universal chassis frame for configurable electric trucks that can support gross vehicle weights across a range of medium-duty classes of commercial trucks.

### BACKGROUND

Electric vehicles powered by battery systems, rather than combustion engines, are gaining popularity due to improved battery life and performance. Most of these advances, however, have been with respect to electric passenger vehicles. While there have been various efforts at developing light duty electric pickup trucks and, more recently, some attempts to develop electric semi-trucks for long-haul tractor trailers, there has been relatively little focus on developing electric trucks in the medium-duty classes of trucks with gross vehicle weight ratings (GVWR) in the range of 10,001-26,000 lbs (4,500-10,500 kg), commonly used for commercial purposes but also non-commercial uses such as recreational vehicles.

One of the primary challenges in developing electric vehicles of any kind relate to the greater weight and limited range capacity of the batteries used to power these vehicles. These challenges are increased with respect to medium-duty electric commercial trucks that can require power for both propulsion and cargo, as well as for auxiliary power requirements for a payload/working unit. For example, the simplest solution to increased travel ranges would be adding more batteries, but any increase in battery weight can impact the effective load carrying capacity of electric trucks as compared to similarly configured combustion powered trucks.

Skateboard/platform frame constructions for a body-on-frame type of vehicle have been proposed for electric passenger vehicles as described, for example, in U.S. Pat. Nos. 6,227,322, 8,739,907, 10,112,470, 10,131,381, and 10,919,575 and U.S. Publ. Appl. Nos. 2019/0351750 A1, 2020/0369140 A1, and 2021/0024131 A1. Unfortunately, the weight carrying capacity and other structural limitations for these types of frames have generally limited their use to light duty electric trucks, such as pickup trucks and delivery vans.

Existing designs for chassis frames for medium duty electric commercial trucks are generally based either on a retrofit of existing commercial combustion truck chassis designs or on purpose-built chassis designed for a specific class and type of commercial trucks. In a typical ladder-frame construction used in medium duty trucks various factors generally limit where battery units can be carried in a retrofit or purpose-built design to locations that are behind the cab and/or outside of the chassis frame, for example, in positions where current fuel tanks are located. U.S. Publ. Appl. No. 2020/0231212 A1 describes an improved ladder frame for a straight truck chassis that includes web structures to enhance the frame to enable batteries, for example, to be carried outside of the two frame rails. U.S. Publ. Appl. No. 2020/03315366 A1 describes an improved ladder frame for a straight truck chassis that includes battery units that are carried transverse to the two frame rails and extend outward from the rails to the perimeter of the truck. U.S. Pat. No. 10,899,387 describes an improved ladder frame for a semi-truck chassis that includes dual level structures to enable a lower level of batteries to be carried outside of the two frame rails. U.S. Pat. No. 10,493,871 describes a chassis frame for a semi-truck chassis with a component assembly that extends across the entire width of the truck to support batteries and has a rigidity and flexibility different from that of the chassis frame. U.S. Publ. Appl. No. 2021/0046978 A1 describes a platform type chassis for a bus or truck that includes multiple battery sub-chassis compartments that extend across the width of the vehicle.

Improvements in the design and configuration of truck chassis frames, especially for medium-duty classes of commercial electric trucks would be desirable.

### SUMMARY

A universal chassis frame for configurable electric trucks is disclosed that can support gross vehicle weights across a range of medium-duty weight classes for commercial trucks and is configured to interface with any of a set of multiple configurable rear payload modules. In embodiments, the universal chassis frame includes a central frame having a pair of main frame rails configured to support at least two battery modules substantially within an intra-frame space defined between the pair of main frame rails and between at least a pair of cross members transversely interconnected to the pair of main frame rails. A front subframe is configured to support a cab, the front portion including a pair of upper frame members mounted directly above the corresponding pair of the main frame rails, and a front axle unit mounted under the front subframe. A rear subframe includes a common connection interface configured to support any of the set of multiple configurable rear units and at least one rear axle unit mounted under the rear subframe. Each axle unit has a single electric motor powered by a battery management system. In various embodiments, each motor is mounted forward of the corresponding axle unit. In various embodiments, the battery management system manages the distribution of electrical power from the at least two battery modules to both the motors for propulsion as well as to any auxiliary power used, for example, by the rear payload module.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a perspective view of a cab chassis vehicle, according to an embodiment.

FIG. 2 is a left elevation view of FIG. 1.

FIG. 3 is a perspective view of a chassis, according to an embodiment.

FIG. 4 is a top plan view of FIG. 3.

FIG. 5 is a bottom plan view of FIG. 3, with additional components depicted.

FIG. 6 is a perspective view of a frame, according to an embodiment.

FIG. 7 is a left elevation view of FIG. 6.

FIG. 8 is top plan view of FIG. 6.

FIG. 9 is a perspective view of a front subframe, according to an embodiment.

FIG. 10 is a schematic of the common design platform of a reconfigurable cab chassis electric truck in different configurations.

FIG. 11 is a schematic of different embodiments of an electric truck with different implementations of the common design platform of a reconfigurable cab chassis of FIG. 10.

FIG. 12 is a schematic of different embodiments of a rear portion on an embodiment of a chassis for the different implementations of a reconfigurable cab chassis electric trucks shown in FIG. 11.

FIG. 13 is a schematic of different embodiments of a rear portion on an embodiment of a chassis as shown in FIG. 3.

FIG. 14 is an overlay schematic of different embodiments of a cab portion with respect to a front portion of an embodiment of a chassis as shown in FIG. 3.

FIG. 15 is a perspective view of a low cab forward vehicle, according to an embodiment.

FIGS. 16A and 16B are each a perspective view of a conventional truck cab recreational vehicle, according to further embodiments.

FIG. 17 is photographic perspective view of an embodiment of a chassis as shown in FIG. 3.

FIG. 18 is photographic side view of an embodiment of a chassis as shown in FIG. 3 with the battery units uninstalled.

FIGS. 19A and 19B are a photographic front view and rear view, respectively, of an embodiment of a front portion of the chassis as shown in FIG. 3.

FIGS. 20A and 20B are a photographic side front view and rear view, respectively, of an embodiment of a cab chassis vehicle as shown in FIG. 1.

FIGS. 21A and 22B are each a perspective view of a frame axle cradle for a front axle unit and a rear axle unit, respectively, according to further embodiments.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Embodiments disclosed herein are directed to aspects of chassis and frame components, configurations, and constructions thereof, and to electric truck vehicles having such chassis and frame components.

As used herein, terms of direction or spatial orientation shall be generally understood according to their ordinary and customary meanings. By way of partial examples, “longitudinal” refers to a lengthwise direction or primary direction of travel of the vehicle, e.g., in the forward or rearward directions as commonly understood: “lateral” or cross refers to a direction generally transverse to longitudinal: “fore” or forward refers to the front of the vehicle with respect to the primary direction of travel: “aft” or rearward refers to the rear of the vehicle with respect to the primary direction of travel: “left” is in relation to facing forward: “right” is in relation to facing forward: “down” or below refers to the direction of the ground or surface on which the vehicle is intended to be operated: and “up” or above refers to a direction generally opposite of down.

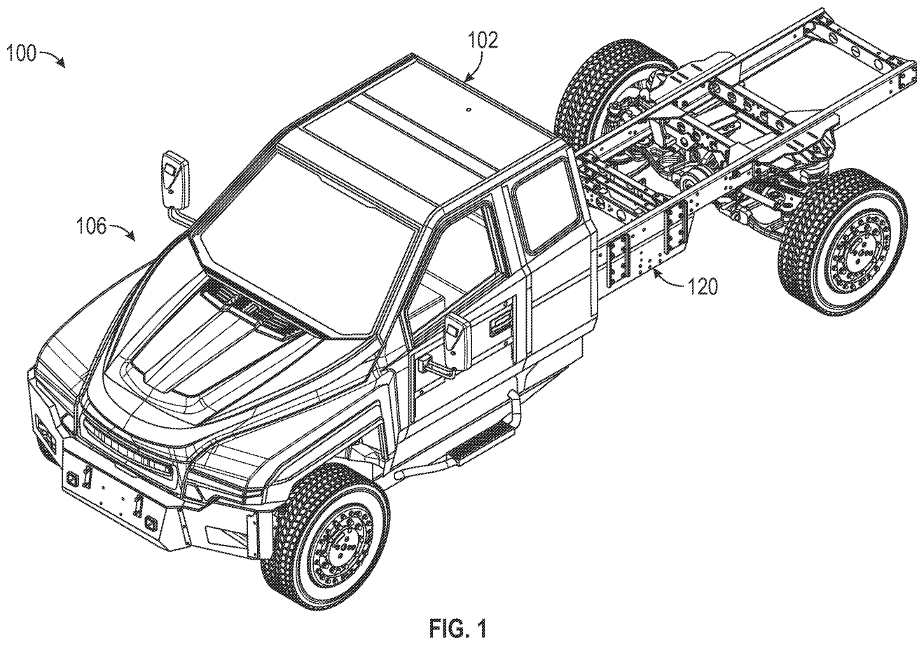

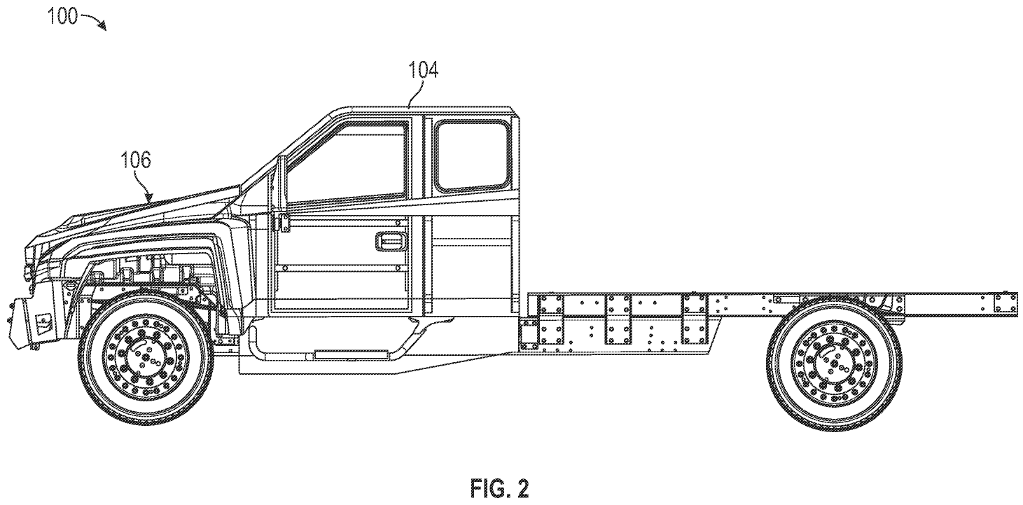

Referring now to FIGS. 1-2, a vehicle 100 is depicted, including a cab 102 coupled to a chassis 120. In an embodiment, vehicle 100 may be configured as a “cab chassis” or “chassis cab” vehicle as depicted, for supply to an upfitting specialist for final configuring as one of many types of vehicles or truck with configurable rear portions such as: service truck, flatbed, box truck, dump truck, garbage truck, street cleaner, roll off truck, bus, mini-bus, recreational vehicle, and the like. In another embodiment, vehicle 100 may be configured fully assembled with a configurable rear portion 120 already provided and attached for delivery to an end customer.

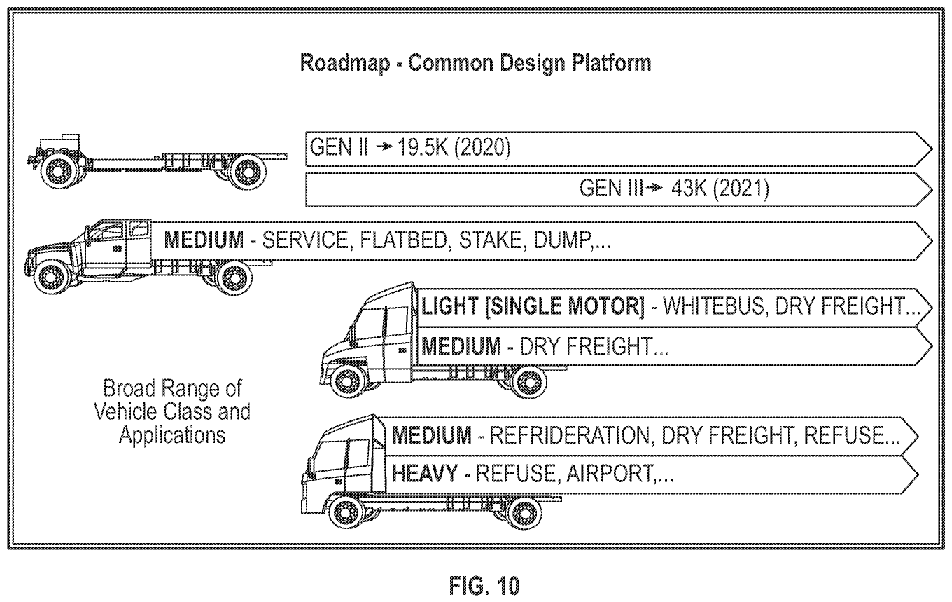

As shown in FIGS. 10-13, medium-duty electric trucks in accordance with various embodiments of a common electric truck chassis-frame approach that provides a common design platform for such vehicles is configurable to meet the mission needs of vocations such as municipalities, utilities, construction, refuse and emergency vehicles. In some embodiments, upfitting kits may be provided for various embodiments of a rear payload module carried by the rear portion 110 of the chassis 120, such as telescopic aerial buckets, cherry pickers, specialty food service, heavy-duty service units, ambulance, rescue, and snow removal. In other embodiments, the electric trucks may include integration with an auxiliary power unit that provides auxiliary power for a myriad of aftermarket tools such as welders, hydraulics, air compressors, generators, or the like, in either or both the rear portion 110 or the cab portion 102 of the vehicle 100.

Cab 102 may include a passenger compartment 104 that may be configured in a variety of manners as desired. As depicted in FIGS. 1-2, passenger compartment 104 may be configured as a two-door extended cab. Optionally, one or more rearward-opening doors may be included for ease of access to space behind the driver and front passenger seats. Passenger compartment 104 may include one or more storage spaces or cubbies therein. In other embodiments, passenger compartment 104 may be configured as a four-door crew cab.

In embodiments, cab 102 may include a frontal compartment 106, defined by a hood, fenders, front grill and firewall. Frontal compartment 106 may include a battery management system, a thermal management system for one or more of electric motors or batteries, and/or HVAC components for cab 102. In some embodiments where at least one of the rear payload modules includes an auxiliary power unit, the battery management system is electrically connectable to the auxiliary power unit to provide auxiliary power in addition to propulsion. In some embodiments, the battery management system provides support for a 12V power distribution separate from either the propulsion and/or auxiliary power distribution systems.

Referring generally to the Figures, chassis 120 may generally include a frame 122 and two or more axle assemblies 170a, 170b. As described in further detail below, frame 122 generally includes one or more frames or frame sections having combinations of longitudinal rails and cross-members, while each axle assembly 170a, 170b may generally include one or more of suspension, wheel, brake or drivetrain components, or combinations thereof. As used herein, “chassis” may be understood to refer only to structural components (e.g., frame 122) of the vehicle, or to refer to structural components in combination with one or more of suspension components or drivetrain components (e.g., axle assemblies 170a, 170b), or to refer to structural components in combination with one or more of suspension components or drivetrain components in further combination with one or more of electric motors and batteries (e.g., a rolling chassis, or a vehicle lacking bodywork).

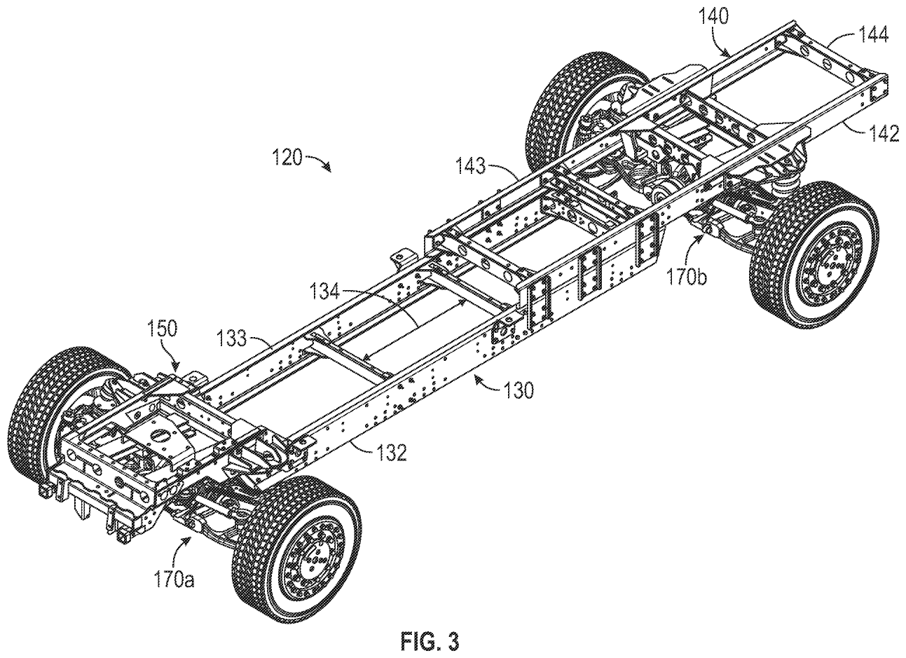

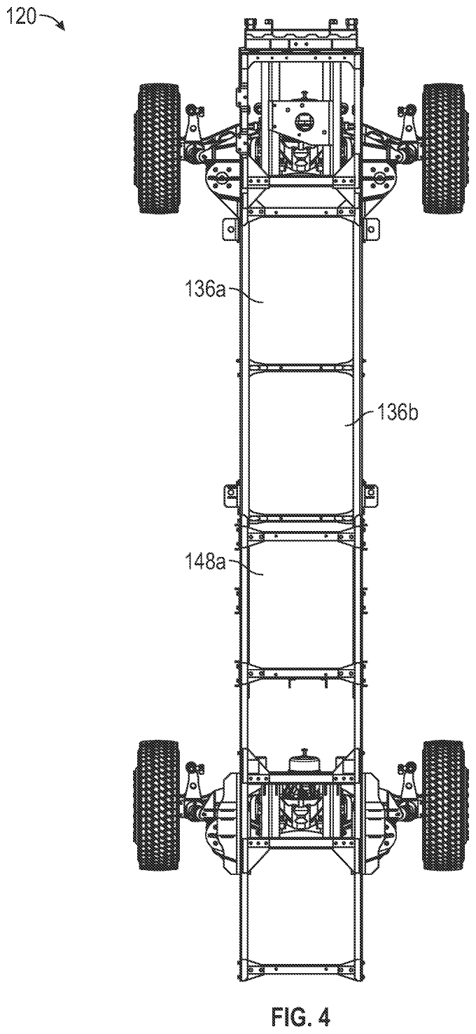

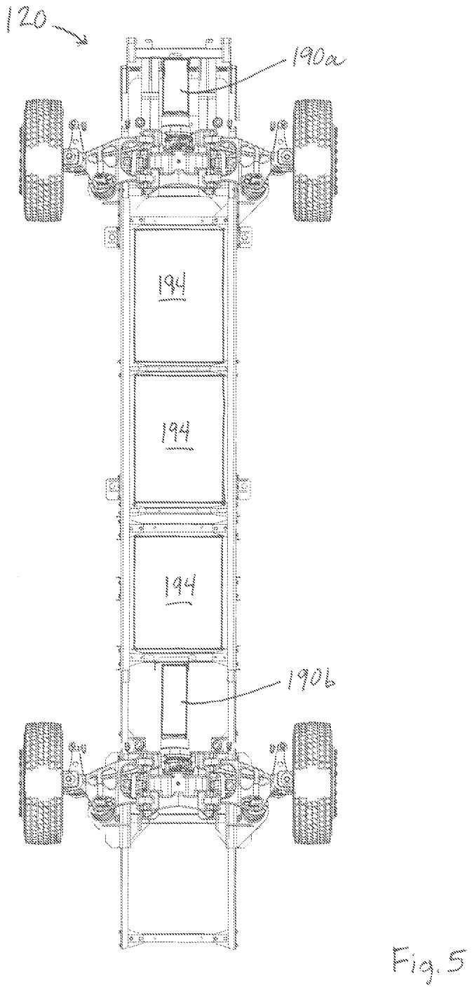

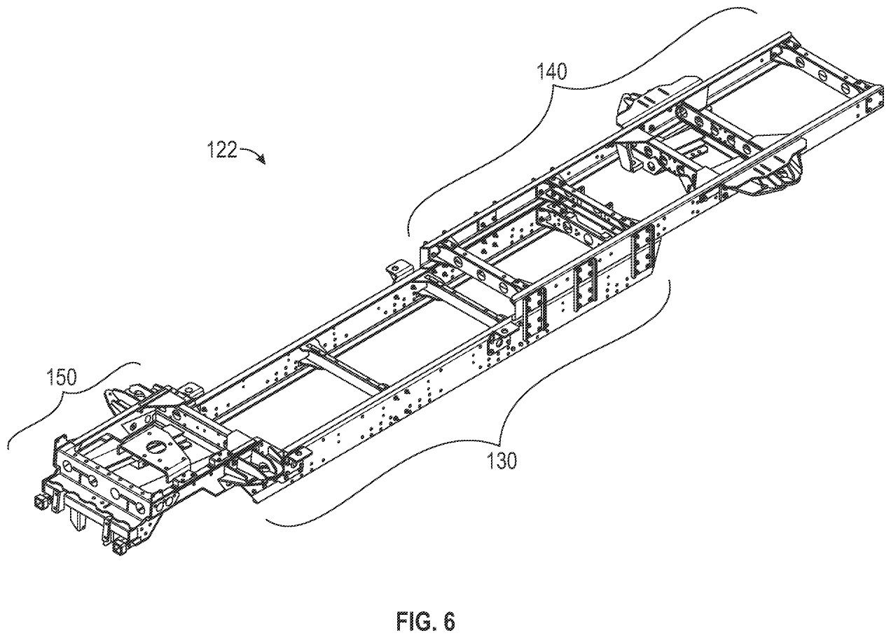

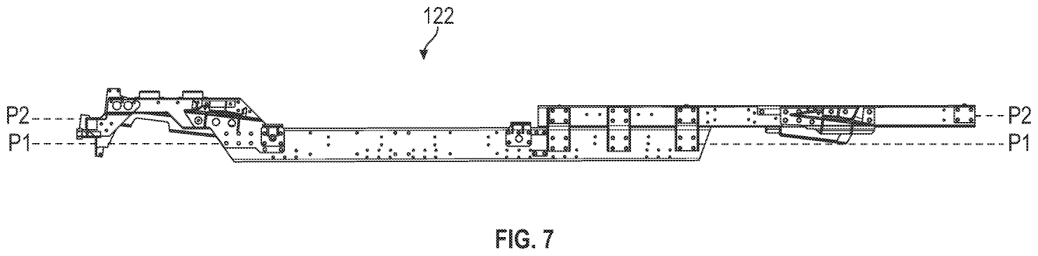

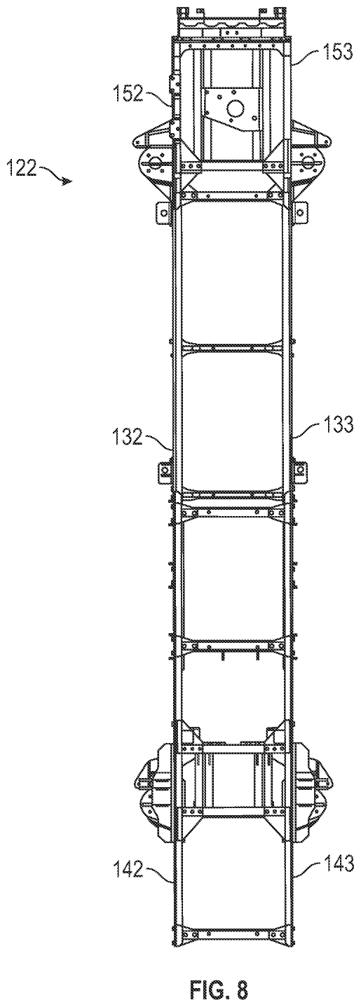

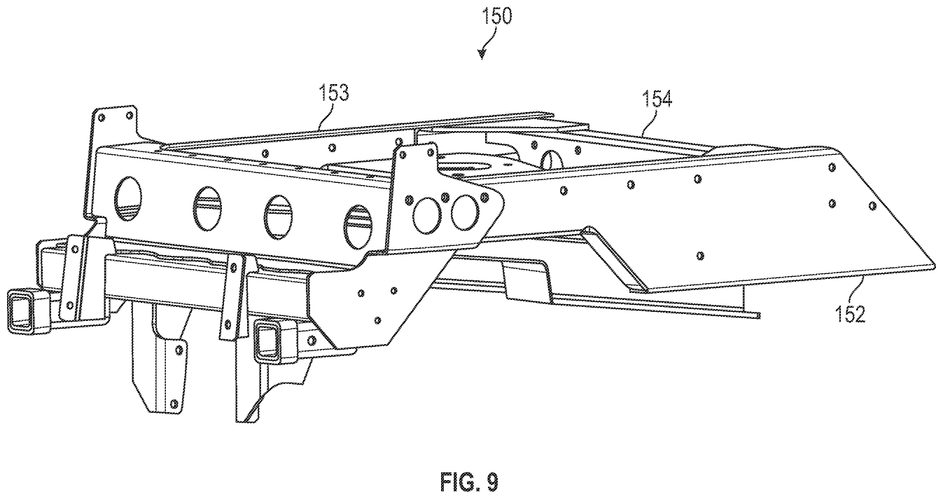

Referring now to FIGS. 3-9, frame 122 may comprise a central frame portion 130, a rear subframe 140 coupled to the central frame portion 130, and a front subframe 150 coupled to the central frame portion 130. In other embodiments not pictured, either one of rear subframe 140 or front subframe 150 may be omitted with frame portion 130 configured to extend substantially to the rear or the front of the vehicle, respectively, as necessary.

Central frame portion 130 may include a first or left central frame rail 132, and a second or right central frame rail 133 joined thereto by one or more cross-members 134. As depicted generally in the Figures, frame rails 132, 133 may comprise an inwardly facing C-shaped profile, although other profile configurations of the frame rails such as boxed, tubular, or others are contemplated. Frame rails 132, 133 are generally parallel to one another. Frame rails 132, 133 generally define, or are horizontally aligned along, a first plane P1. In an embodiment, each of frame rails 132, 133 may have a height within a range of approximately four to twelve inches, and in another embodiment a height of approximately ten inches, although other sizes are contemplated. In various embodiments, a profile (or height) of frame rails 132, 133 may be generally consistent along a longitudinal length, although various tapered, notched or step sections may be included at different longitudinal locations along the frame rails as desired.

Cross-members 134, as depicted generally in the Figures, may comprise a boxed I-beam configuration, although in other embodiments C-shaped, tubular or other configurations of the cross-members are contemplated. In various embodiments, the number, placement and orientation of cross-members 134 depicted in the Figures may be considered merely exemplary and not limiting.

Central frame portion 130 may include or otherwise be coupled with various brackets or attachments, such as for example body mounting brackets for attachment of cab 102 thereto. Additionally, central frame portion 130 may also include or otherwise define one or more intra-frame spaces 136 for the receipt and mounting of batteries or battery modules (or packs) 194 therein. In an embodiment, a battery module 194 mounted within an intra-frame space 136 may be sized and configured such that battery module 194 generally fits within a side profile (or height) of the frame rails of central frame portion 130 such that battery module 194 when installed does not extend laterally beyond the frame rails 132, 133 and does not protrude significantly above or below the height of frame rails 132, 133.

Referring now to rear subframe 140, a first or left rear frame rail 142 and a second or right rear frame rail 143 may be included. One or more rear cross-members 144 configured to connect frame rails 143, 144 may also be included as part of rear subframe 140. As depicted generally in the Figures, frame rails 142, 143 may comprise a C-shaped profile, although other configurations such as boxed, tubular, or others are contemplated. Frame rails 142, 143 are depicted as being generally parallel to one another, however other configurations are contemplated such as tapered width wherein the distance between frame rails is not constant. Frame rails 142, 143 generally define, or are horizontally aligned along, a second plane P2. In an embodiment, each of frame rails 142, 143 may have a height within a range of approximately four to twelve inches, and in another embodiment a height of approximately six inches, although other sizes are contemplated. The profile of frame rails 142, 143 may be generally consistent along a longitudinal length, although various tapered, notched or step sections may be included at different longitudinal locations along the frame rails as desired.

Rear cross-members 144, as depicted generally in the Figures, may comprise a boxed configuration, although in other embodiments c-shaped, tubular or other configurations are contemplated. In embodiments, the exact number, placement and orientation of cross-members 144 depicted in the Figures may be considered merely exemplary and not limiting.

Rear subframe 140 may include or otherwise be coupled with various brackets or attachments, such as for example brackets or other means for attachment of a rear payload module or accessory to the rear portion 110 of vehicle 102 such as but limited to a flatbed, utility boxes, enclosed box, dump box, and the like. In various embodiments, frame rails 142, 143 are provided with a uniform set of bolt hole patterns to be used for attachment of rear payload module. In embodiments, a uniform set of bracket assemblies include a lower set of bolt holes that interface with the bolt hole patterns on the frame rails, and an upper portion of individual brackets includes attachment mating structure appropriate for securing one or more different types of rear payload modules. In embodiments, the bolt hole patterns and bracket assemblies are configured to provide structural support and integrity to attach and carry rear payloads for rail frames having a standardized frame width, e.g., 34 inches.

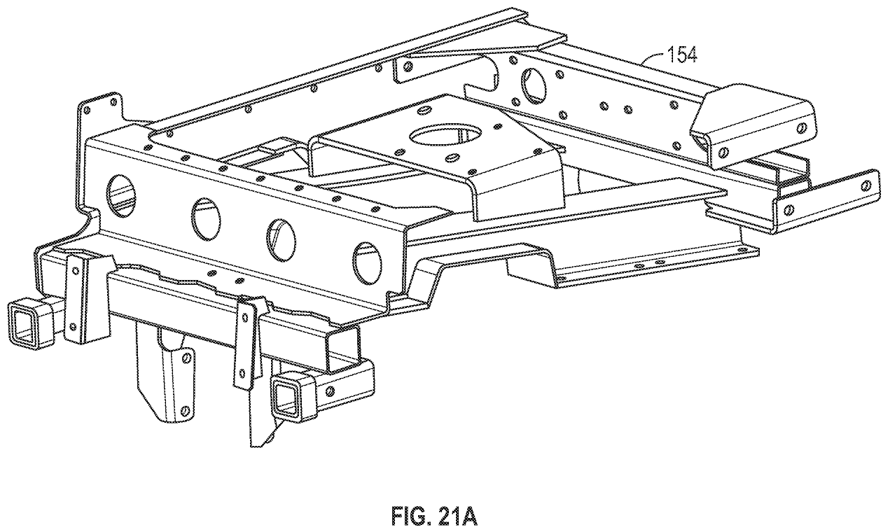

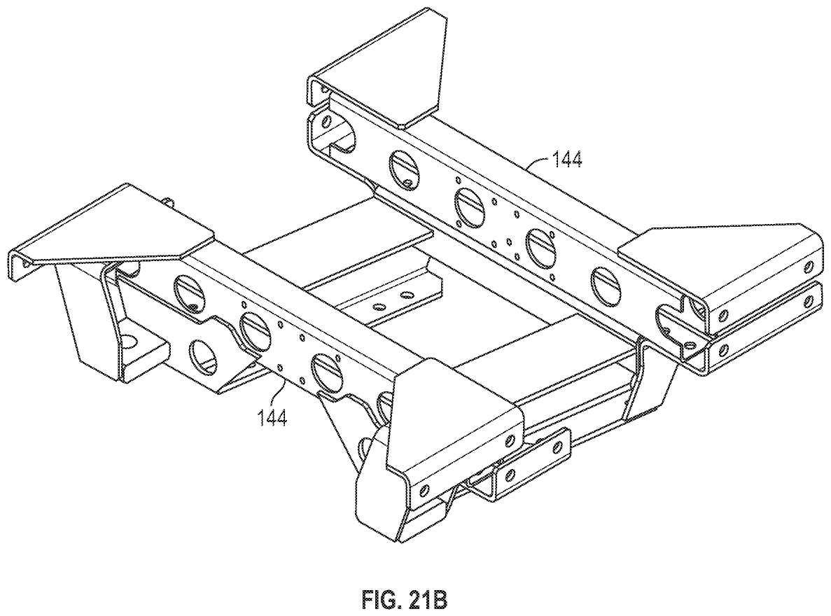

Rear subframe 140 may also include one or more brackets, mounting points or other means for attachment of at least one axle assembly 170 thereto. In various embodiments as shown in FIG. 21A, rear subframe 140 includes an axle mount structure formed of a pair of secondary frame rails each having a C-shaped cross-section oriented inwardly and a pair of cross-members each having an I-shaped cross-section. As shown in this embodiment, rear subframe 140 includes a rear-weldment assembly that includes a cradle for rear axle that can slide back and forth to be positioned longitudinally at different locations along rear subframe 140 to accommodate different longitudinal positions of the rear axle.

Rear subframe 140 is configured to be coupled to central frame portion 130, such as by use of brackets for connection therebetween as generally depicted in the Figures, or alternately by direct coupling therebetween, or a combination thereof. Rear subframe 140 may overlap with central frame portion 130 as desired for strength, rigidity, load-carrying capabilities, other advantages, or combinations thereof. As depicted in the Figures, rear subframe 140 may overlap with central frame portion 130 such that rear subframe 140 extends generally close to the rear of cab 102. In other configurations rear subframe 140 may overlap with central frame portion 130 to a lesser or greater amount than is depicted in the Figures, such as by less than a foot to a few feet or more.

Additionally, rear subframe 140 may also include or otherwise define one or more intra-frame spaces or compartments 148a-c for the receipt and mounting of batteries or battery packs 194a-c therein. In an embodiment, an individual battery module 194 mounted within a given compartment 148 may be sized and configured such that battery 194 fits within a side profile (or height) of the frame rails of rear subframe 140 such that battery 194 when installed does not protrude above or below the height of frame rails 142, 143.

Referring now to front subframe 150, a first or left front frame rail 152 and a second or right front frame rail 153 may be included. One or more front cross-members 154 configured to connect frame rails 153, 154 may also be included as part of front subframe 150. As depicted generally in the Figures, frame rails 152, 153 may comprise a C-shaped profile, although other configurations such as boxed, tubular, or others are contemplated. Frame rails 152, 153 are depicted as being generally parallel to one another, however other configurations are contemplated such as tapered width wherein the distance between frame rails is not constant. Frame rails 152, 153 generally define, or are horizontally aligned along, second plane P2. In an embodiment, each of front frame rails 152, 153 may have a height within a range of approximately four to twelve inches, although other sizes are contemplated. The profile of frame rails 152, 153 may be generally consistent along a longitudinal length, although various tapered, notched or step sections may be included at different longitudinal locations along the frame rails as desired. As depicted, each of front frame rails 152, 153 include a stepped profile with a relatively taller rearward section and a relatively shorter frontal section.

Front cross-members 154, as depicted generally in the Figures, may comprise a boxed configuration, although in other embodiments C-shaped, tubular or other configurations are contemplated. In embodiments, the exact number, placement and orientation of cross-members 154 depicted in the Figures may be considered merely exemplary and not limiting.

Front subframe 150 may include or otherwise be coupled with various brackets or attachments, such as for example brackets or other means for attachment for crash structures, bodywork, underhood components, front-mounted components such as a winch or snowplow, or other accessories. Front subframe 150 may also include one or more brackets, mounting points or other means for attachment of axle assembly 170 thereto. Front subframe 150 is configured to be coupled to central frame portion 130, such as by use of brackets for connection therebetween as generally depicted in the Figures, or alternately by direct coupling therebetween, or a combination thereof. Front subframe 150 may overlap with central frame portion 130 as desired for strength, rigidity, load-carrying capabilities, other advantages, or combinations thereof. Front subframe 150 may overlap with central frame portion 130 in a range between generally less than a foot, up to a few feet.

In embodiments such as shown in FIG. 21B, front subframe 150 includes a front-weldment assembly with I beams and C channels configured to attach both the axle assembly and at least a portion of the cab to the front subframe 150. In some embodiments, the front-weldment assembly is similar to the rear-weldment assembly except that a cradle for front axle assembly is fixed and cannot be positioned at different longitudinal locations along the frame front subframe 150.

The modular arrangement of frame 122 including central frame portion 130, rear subframe 140 and front subframe 150 provides advantages for reconfigurability and repair of vehicle 100. For example, rear subframe 140 could simply be unbolted and replaced with a different rear subframe of different dimension and/or construction to configure vehicle 100 for a different use or purpose such as: service truck, flatbed, box truck, dump truck, garbage truck, street cleaner, roll off truck, bus, mini-bus, recreational vehicle, and the like. Additionally, if one portion of frame 122 becomes damaged or otherwise unusable, that component (130, 140, 150) may be easily replaced without having to replace the entire frame 122.

In various embodiments, the range of payloads and GVWR for a commercial electric truck utilizing the common chassis frame as disclosed generally can be up to a maximum of the combination of the axle ratings minus the weights of the chassis frame, battery units, cab and auxiliary features. In one embodiment in which the front axle rating is 7,300 pounds and rear axle rating is 16,000 pounds for a total gross vehicle weight rating of 22,300 lbs. In various embodiments the weight of the chassis frame and the battery units are each in the range of 1,500-3,000 lbs, depending upon configuration (e.g. front-wheel drive vs. all-wheel drive) and the total number of battery packs (e.g., 2-4+), which combined with a range of 500-4,000 lbs for the weight of the cab, passengers, and auxiliary units generate a payload range for these embodiments up to 16,000 lbs. In various embodiments, the total payload capacity can be allocated between rear module payload weight and cargo payload weights according to the specific type of rear payload module for which the vehicle is configured.

In various embodiments, the frame rails can be formed of 80 k tensile high-strength/low-alloy (HSLA) steel and the other metal materials and members are formed of 50 k HSLA steel. In some embodiments, the steel members are formed of ASTM 6560 Grade 80 material. In some embodiments, the aluminum members are formed of Aluminum 5052 and/or Aluminum 6061 T6. In various embodiments, a resistance bending moment (RBM) for the frame rails and/or frame chassis can range from 1-4 million, depending upon configuration, material and construction of the chassis frame.

Referring now to axle assemblies 170, the term “axle” as used therein refers to components associated with wheel pairs of the vehicle (e.g., a front axle assembly 170a or a rear axle assembly 170b), and not refer only to an axle or shaft component. Each axle assembly 170 may include suspension components, such as springs, dampers, and a-arms as depicted in the Figures, to comprise an independent suspension. In other embodiments, suspension components may be of any variety of suspension arrangements as known in the art, including independent or dependent. Each axle assembly 170a, 170b may also include braking components, such as outboard mounted disc brakes as depicted in the Figures, or other outboard or inboard braking arrangements as known in the art. Each axle assembly 170a, 170b may also include a differential and half-shafts, or other drive arrangements. At least front axle assembly 170a may include or otherwise couple with a steering rack and other steering components. In an embodiment, rear axle assembly 170b may also include or otherwise couple with a steering rack and other steering components so as to allow the rear wheels of vehicle 100 to be steerable.

In an embodiment, front axle assembly 170a and rear axle assembly 170b may be substantially similar or even identical, with or without the exception of any steering-related components. In such an arrangement, repair or replacement of individual components (or the entire axle assembly) is simplified by requiring fewer unique parts for the vehicle. Each axle assembly 170 may be coupled with or removed from frame 122 as a complete assembly.

Although not depicted, it will be understood vehicle 100 may be provided with additional axle assemblies, for example an additional rear axle arrangement so as to create a tandem axle configuration. Optionally, rear subframe 140 may be lengthened or otherwise modified to accommodate additional axles assemblies as needed. Any additional axle assemblies may be driven axles or may be non-driven.

Referring now to propulsion of vehicle 100, one or more electric motors 190 may be included. In an embodiment, a single electric motor 190 may be included with one of axle assemblies 170. In another embodiment, an electric motor 190 may be included with each of axle assemblies 170a, 170b, for a total of two electric motors 190a, 190b. As generally depicted in the Figures, electric motors 190a, 190b are mounted generally along a longitudinal centerline of frame 122, being coupled between axle assemblies 170a, 170b and portions of frame 122. Also as depicted in the Figures, electric motors 190a, 190b are positioned forward of axle assemblies 170a, 170b. As depicted herein, vehicle 100 is configured to drive all four wheels. Vehicle 100 may also be configured to selectively operate only one electric motor depending on driving conditions, for example during steady-state operation. In some embodiments, vehicle 100 may have a single (front) electric motor 190a configured as a front-wheel drive electric truck suitable for a GVWR of up to 17,000 lbs (7,750 kg). Providing power to electric motor(s) 190 may be two or more batteries or battery packs 194.

As depicted generally in the Figures, vehicle 100 includes three battery packs 194, although greater or fewer batteries are also contemplated. Suitable battery types include lithium-ion, lithium iron phosphate (LiFePOx), or other types such as hydrogen (fuel cell), LiCo, LiNiCoAl, and LiTi. In embodiments, suitable total battery capacity for vehicle 100 may be 105 kWh or more, 150 kWh or more, 200 kWh or more, 250 kWh or more, 400 kWh or more. Generally the size, configuration and placement of battery packs 194 should be selected for convenient placement and packaging with respect to frame 122. Additionally, one or more battery packs 194 may be sized and configured to fit within the boundaries of one or more generally longitudinal frame rails, such that the one or more battery packs are inboard of the frame rails and located in an intra-frame space. In another embodiment, one or more battery packs 194 may be sized and configured to fit within a battery compartment defined by one or more frame rails and cross-members.

In an embodiment, one or more battery packs 194 may be sized and configured to fit within a side profile (or height) of individual frame rails, such that when viewed from the side the battery pack does not extend or protrude above or below a profile defined by a frame rail. In another embodiment, one or more battery packs 194 may be sized and configured to fit within one of an upper or lower bound of a profile of a frame rail (e.g., the battery back may extend above, but not below a side profile of a frame rail, or alternatively the battery back may extend below, but not above a side profile of a frame rail). In various embodiments, the height of a given battery pack 194 does not extend to more than 130% of a height of a corresponding frame rail. In some embodiments, the height of a given battery pack 194 does not extend to more than 120% of a height of a corresponding frame rail. In some embodiments, any height of a given battery pack 194 that extends above or below the side profile of a corresponding frame member extends further above than below to not impact the ground clearance of the vehicle.

In other embodiments, one or more battery packs 194 may be sized and configured to be mounted to vehicle 102 in other arrangements such as mounted below or above one or more frame rails or mounted in a behind-the-seat arrangement with respect to cab 102. In another embodiment, one or more battery packs 194 may be sized and configured without regard to proportions of the frame rails of vehicle 102. In some embodiments, a protection plate may be included before one or more of the battery packs 194 to improve protection against damage to the battery pack by road debris or ground terrain, such as boulders, rocks or curbs.

The size, configuration and placement of components of vehicle 102, particularly of battery packs 194, provides advantages for vehicle dynamics and weight/load distribution. For example, in some embodiments, the center of gravity (CG) of an unladen vehicle 102 without accounting for any operator or payload weight is engineered to be proximate a center of vehicle in plan view, e.g. (˜0-4″ of a center line of the wheel base and ˜2″-10″ above a plane of a top of the pair of frame rails).

Embodiments described herein may be suitable for vehicles of gross vehicle weight ratings (GVWR) between 10,001 pounds and 26,000 pounds, generally known as Class 3-Class 6 vehicles in the United States. In various embodiments, the range of dimensions from the back of the cab to the rear axle can be between 60″-200″. In various embodiments, the range of dimensions from the rear axle to the back of the rear frame can be between 30″-80″. In various embodiments, these dimensional ranges are sufficient to accommodate a wide variety of rear modules for Class 3-6 trucks on the common frame chassis embodiments as disclosed.

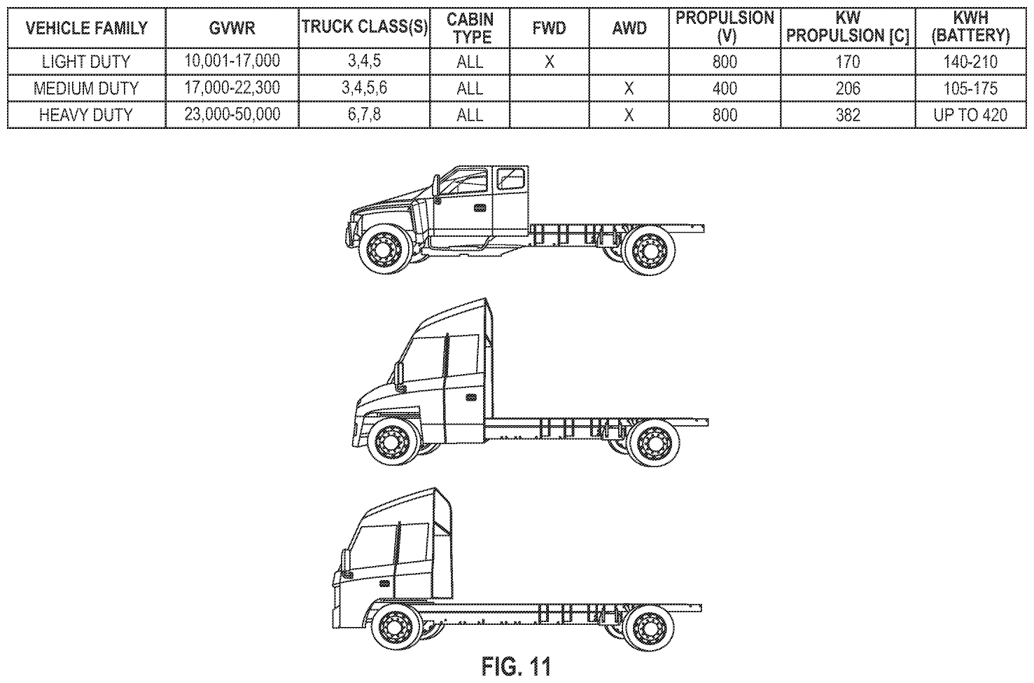

As shown in FIG. 10, a common bed design for medium duty electric trucks 102 in accordance with various embodiments of the present disclosure allows a common frame design to accommodate a broader range of GVWR while providing a common interface structure for various different types of configurable rear portions 110. FIG. 11 presents a table of GVWR ratings with respect to different cab types of various embodiments of the present disclosure.

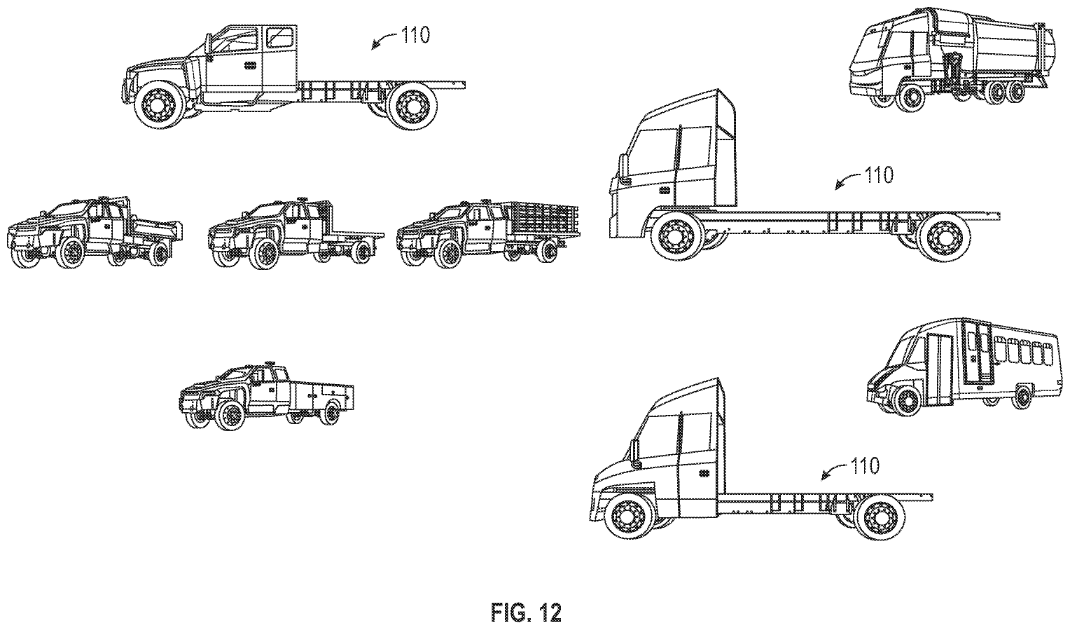

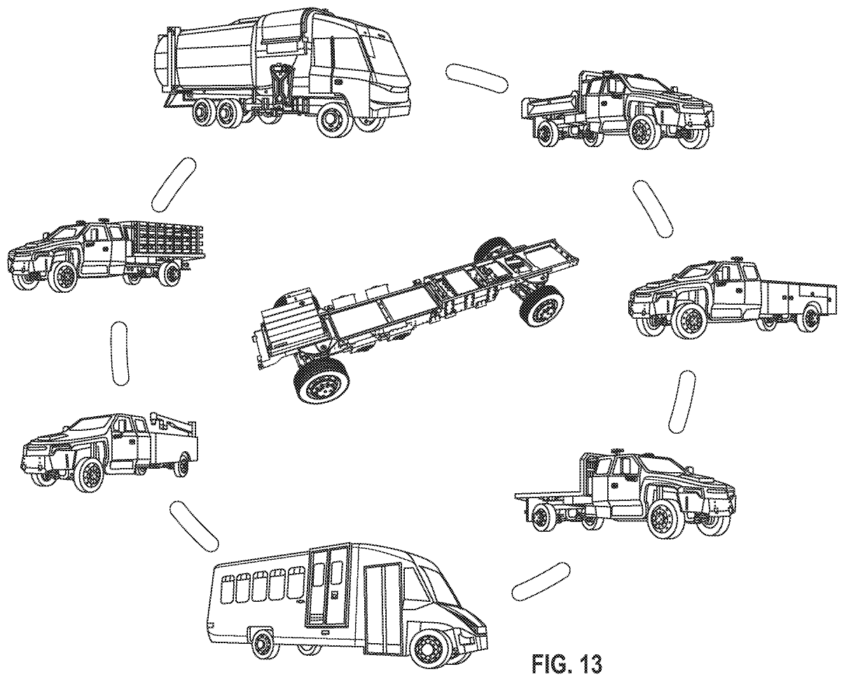

FIGS. 12 and 13 show different various embodiments of configurable rear portions 110 with different cabs 102 that may be carried on the common chassis 120.

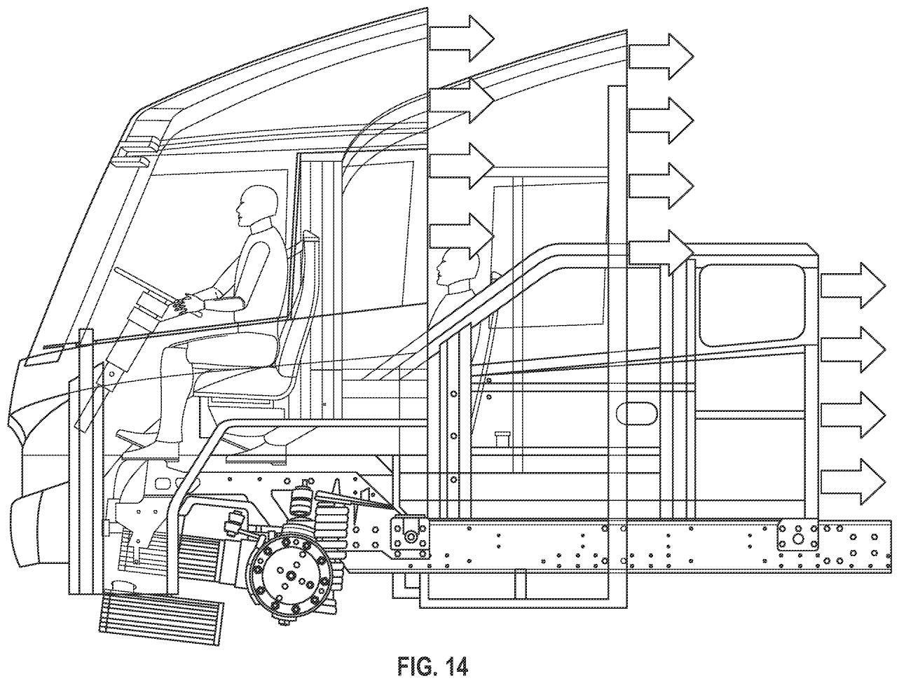

FIG. 14 shows the relative differences of different cabs 102 as mounted on an embodiment of the common chassis 120.

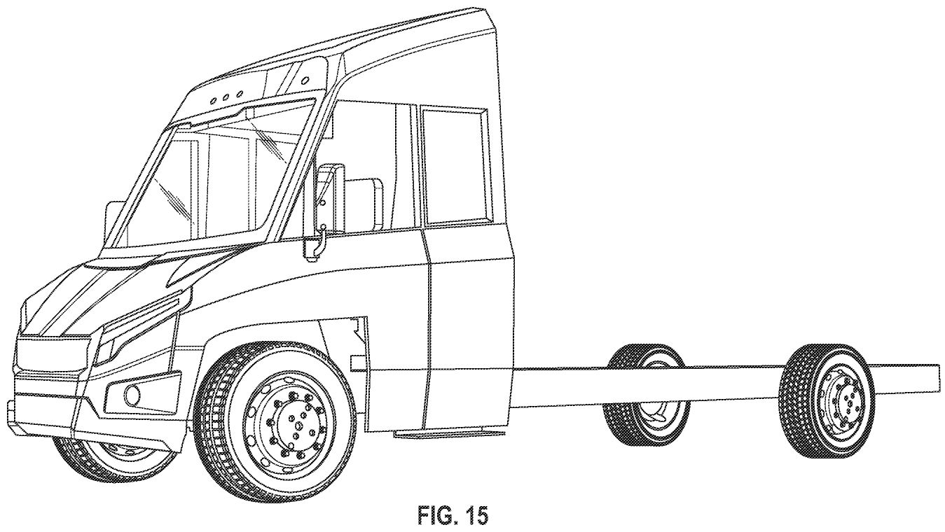

FIG. 15 is a schematic depiction of a low cab forward embodiment that would be utilized, for example, for cut-away and non cut-away applications to provide for enhanced cab visibility, multiple cab roof heights. In various embodiments, the low cab forward embodiment of cab 102 of FIG. 15 may be utilized with a transit bus rear portion 120. In various embodiments, the low cab forward embodiment of cab 102 of FIG. 15 is utilized with a front-wheel drive only configuration of chassis 120 as previously described. In various embodiments, the low cab forward embodiment of cab 102 of FIG. 15 can be configured for use as a recreational vehicle, a delivery vehicle, a transit bus or a special purpose custom rear portion 110.

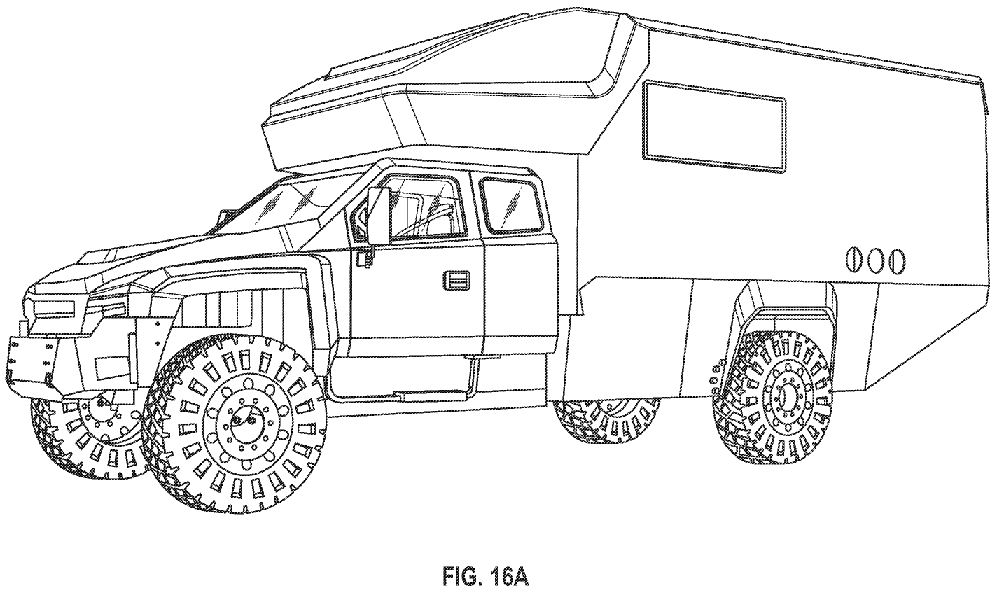

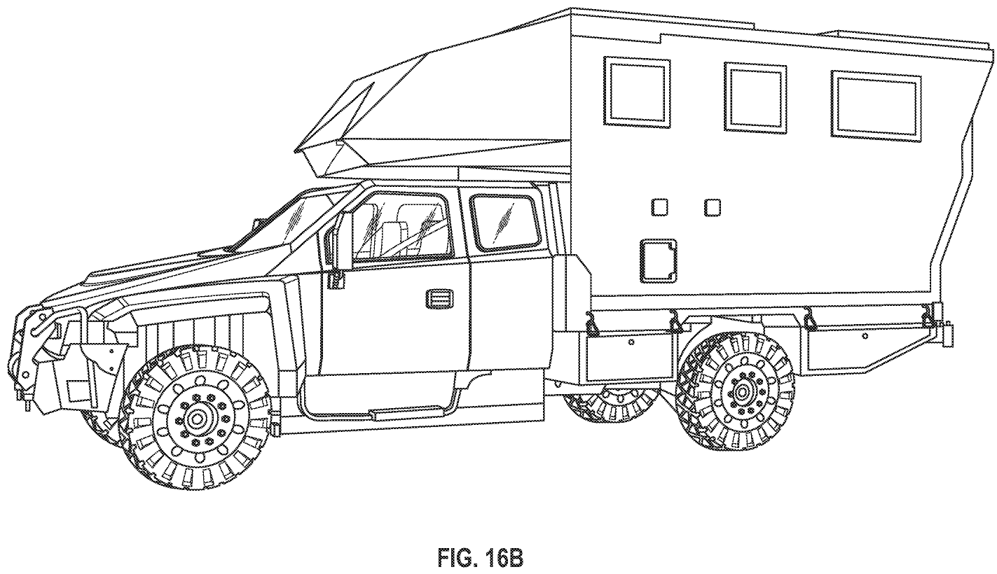

FIGS. 16A and 16B are schematic depiction of a conventional truck embodiment that would be utilized, for example, for overland embodiments, such as for custom recreational vehicles. In various embodiments, the conventional truck embodiment of cab 102 of FIGS. 16A and 16B can be utilized with an all-wheel drive only configuration of chassis 120 as previously described having independent front and rear suspensions.

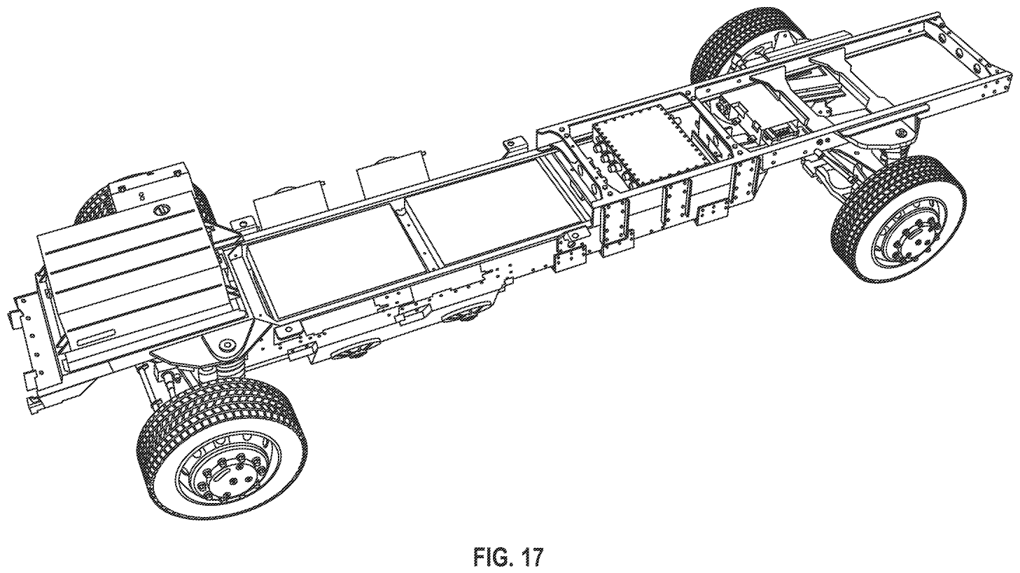

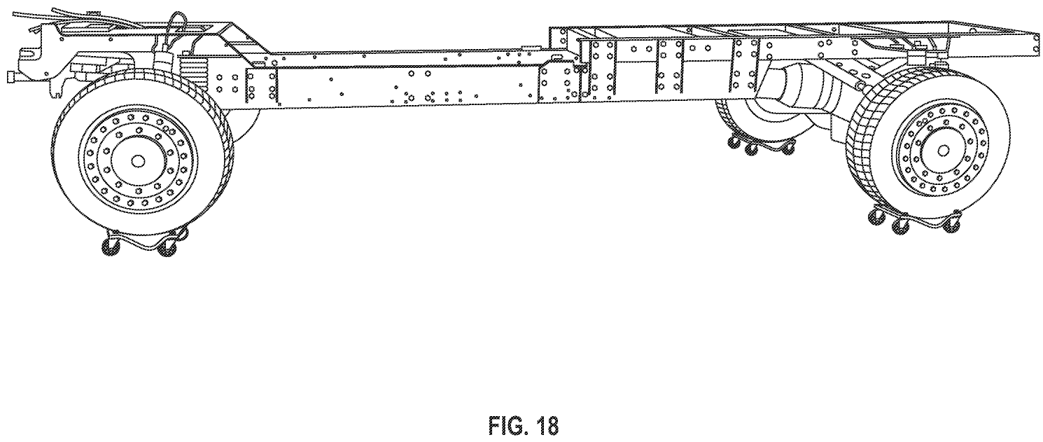

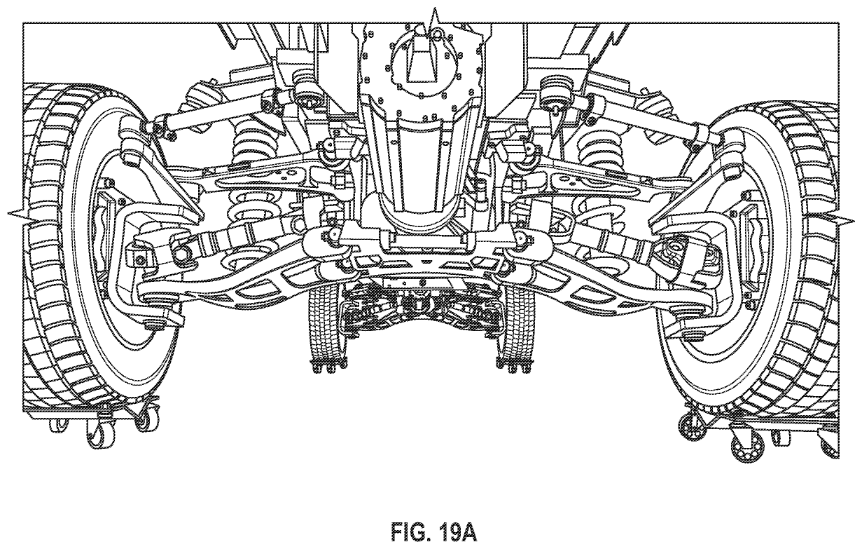

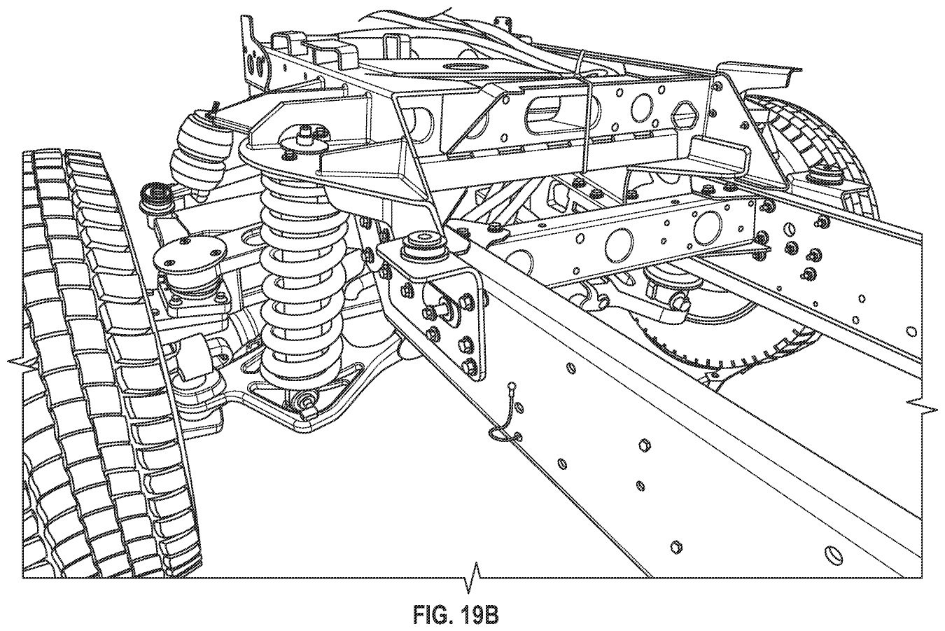

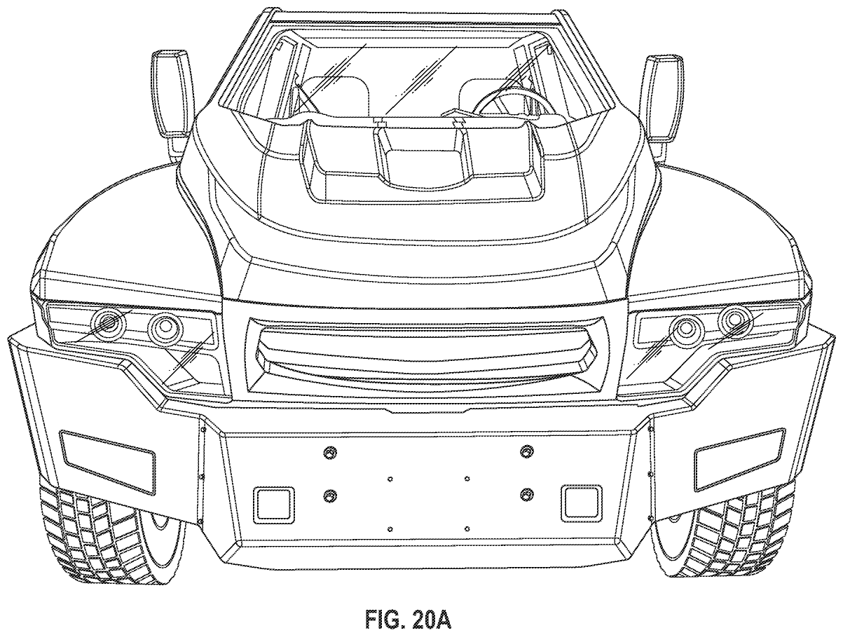

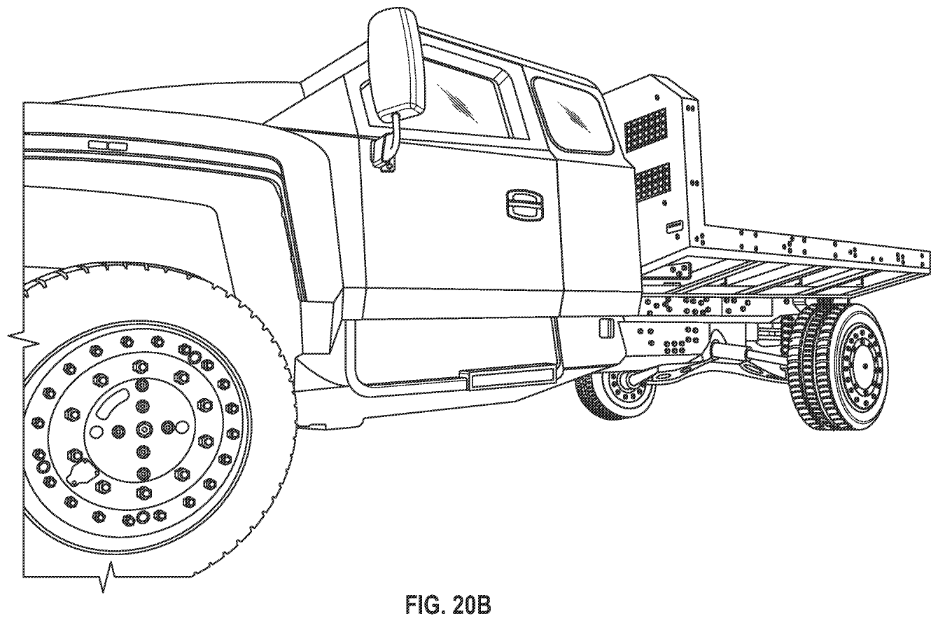

FIG. 17 is photographic perspective view of an embodiment of a chassis as shown in FIG. 3. FIG. 18 is photographic side view of an embodiment of a chassis as shown in FIG. 3 with the battery units uninstalled. FIGS. 19A and 19B are a photographic front view and rear view, respectively, of an embodiment of a front portion of the chassis as shown in FIG. 3. FIGS. 20A and 20B are a photographic side front view and rear view, respectively, of an embodiment of a cab chassis vehicle with a flat bed rear portion as shown in FIG. 1.

The provisional application to which priority is claimed, Ser. No. 63/190,474, is hereby incorporated by reference herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features: rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A universal chassis frame for a configurable electric truck having a gross vehicle weight rating in a range of 10,001-26,000 lbs with the chassis frame configured to interface with any of a set of multiple configurable rear payload modules, the universal chassis frame comprising:
a central frame having a pair of main frame rails configured to support at least two battery modules substantially within an intra-frame space defined between the pair of main frame rails and between at least a pair of cross members transversely interconnected to the pair of main frame rails;
a front subframe configured to support a cab, the front portion including a pair of upper frame members mounted directly above the corresponding pair of the main frame rails;
a rear subframe having a common connection interface configured to support any of the set of multiple configurable rear payload modules; and
a front axle unit mounted under the front subframe and at least one rear axle unit mounted under the rear subframe, each axle unit having a single electric motor powered by the battery modules.

2. The universal chassis frame of claim 1, wherein the electric motor for each of the front axle unit and the at least one rear axle unit is mounted forward of the corresponding axle unit.

3. The universal chassis frame of claim 1, wherein the rear subframe includes a pair of secondary frame rails and at least a pair of cross members, wherein the pair of secondary frame rails are positioned on top of and extend rearward of the pair of main frame rails.

4. The universal chassis frame of claim 3, wherein each of the pair of main frame rails and the pair of secondary frame rails has a C-shaped cross-section oriented inwardly, and each of the at least pair of cross members has an I-shaped cross-section.

5. The universal chassis frame of claim 4, wherein the pair of main frame rails and the pair of secondary frame rails are operably connected by a set of plates extending horizontally there between on an outer side of both of the corresponding frame rails.

6. The universal chassis frame of claim 4, wherein the common connection interface comprises a standard set of mounting holes in the pair of secondary frame rails that are operably connectable by a set of plates extending horizontally above and on an outer side of both of the corresponding secondary frame rails.

7. The universal chassis frame of claim 1, wherein the front subframe includes an axle mount box structure formed of a pair of secondary frame rails each having a C-shaped cross-section oriented inwardly and a pair of cross-members each having an I-shaped cross-section, wherein the front axle unit is only mounted to the axle mount box structure of the front subframe.

8. The universal chassis frame of claim 1, wherein each of the front subframe and rear subframe includes an axle mount box structure formed of a pair of secondary frame rails each having a C-shaped cross-section oriented inwardly and a pair of cross-members each having an I-shaped cross-section, wherein the front axle unit is only mounted to the axle mount box structure of the front subframe and the rear axle unit is only mounted to the axle mount box structure of the rear subframe.

9. The universal chassis frame of claim 1, further comprising a battery management system electrically connected to the at least two battery modules and configured to manage distribution of electrical power from the at least two battery modules to the single electric motor of each axle unit to provide propulsion, and wherein at least one of the rear payload modules includes an auxiliary power unit, and wherein the battery management system is electrically connectable to the auxiliary power unit to provide auxiliary power in addition to propulsion.

10. The universal chassis frame of claim 1, wherein each of the pair of main frame rail has a height within a range of approximately four to twelve inches and is formed of one of an 80 k tensile high-strength/low-alloy steel or an ASTM 6560 Grade 80 material, and wherein the chassis frame has a resistance bending moment that ranges from 1-4 million.

11. The universal chassis frame of claim 1, wherein a center of gravity of the configurable electric truck without accounting for any operator or payload weight is proximate a center of the configurable electric truck in plan view, and more particularly within approximately zero to four inches of a center line of a wheel base defined between a middle of a width of the front axle unit and a middle of the at least one rear axle unit and within approximately two to ten inches above a plane defined by a top of the pair of main frame rails.

12. The universal chassis frame of claim 1, wherein the at least two battery modules are sized and configured to fit within a side profile defined by the pair of main frame rails and wherein the at least two battery modules do not protrude above or above and below the side profile defined by a frame rail of the pair of main frame rails.

13. The universal chassis frame of claim 1, wherein a maximum height of the at least two battery modules does not extend to more than 130% of a height of a corresponding frame rail of the pair of main frame rails, and wherein the maximum height does not extend to more than 120% of the height of the corresponding frame rail of the pair of main frame rails.

14. The universal chassis frame of claim 1, wherein the pair of main frame rails are provided with a uniform set of bolt hole patterns to be used for attachment of any of the set of multiple configurable rear payload modules, and wherein the chassis frame further includes a uniform set of bracket assemblies, the uniform set of bracket assemblies including a lower set of bolt holes that interface with the bolt hole patterns on the frame rails of the pair of main frame rails and an upper portion of individual brackets that includes an attachment mating structure for securing one or more of different ones of the set of multiple configurable rear payload modules.

15. The universal chassis frame of claim 1, wherein the set of multiple configurable rear payload modules is selected to configure the universal chassis frame as one or more of a service truck, a flatbed truck, a box truck, a dump truck, a garbage truck, a street cleaner, a roll off truck, a bus, a mini-bus, a recreational vehicle, a telescopic aerial bucket truck, a cherry picker truck, a food service truck, a snow removal truck, a heavy-duty service truck, an ambulance, and a rescue vehicle.
